(19) United States
(12) Patent Application Publication
(10) Pub. No.: US 2015/0022467 A1
(43) Pub. Date: Jan. 22, 2015

(54) ELECTRONIC DEVICE, CONTROL METHOD OF ELECTRONIC DEVICE, AND CONTROL PROGRAM OF ELECTRONIC DEVICE

(71) Applicant: KABUSHIKI KAISHA TOSHIBA, Tokyo (JP)

(72) Inventor: Masahiro TAKAYAMA, Tokyo (JP)

(73) Assignee: KABUSHIKI KAISHA TOSHIBA, Tokyo (JP)

(21) Appl. No.: 14/176,731

(22) Filed: Feb. 10, 2014

(30) Foreign Application Priority Data
Jul. 17, 2013 (JP) 2013-148849

(51) Int. Cl. G06F 3/0354; G06F 3/041

(52) U.S. Cl. CPC G06F 3/03545; G06F 3/041
USPC 345/173

(57) ABSTRACT

According to one embodiment, an electronic device includes a touch panel display unit configured to receive inputs from a pen device and touch inputs, a reception unit configured to receive inclination information from the pen device. The electronic device further includes a calculation unit that calculates relative inclinations of the touch panel display unit in the electronic device and the pen device based on inclination information from the pen device. The electronic device further includes an instruction unit that issues an instruction providing a touch operation non-detection portion in a portion of a touch panel display unit based on the calculated relative inclinations. The touch operation non-detection portion corresponds to a portion of the display unit where user touch input is purposively not detected (or otherwise ignored) such that input related to operation (e.g., handwriting input) to the pen device may be input.

### CROSS-REFERENCE TO RELATED APPLICATION

This application is based upon and claims the benefit of priority from Japanese Patent Application No. 2013-148849, filed Jul. 17, 2013, the entire contents of which are incorporated herein by reference.

### FIELD

Embodiments described herein relate generally to an electronic device, a control method of an electronic device, and a control program of an electronic device.

### BACKGROUND

Electronic devices including a touch panel display screen have become common. Tablet-type devices and smart phones incorporate this technology and can receive touch input such as multi-touch input, pen input using a pen device (handwriting input pen), or other types of tactile input. Some electronic devices maybe capable of receiving both touch input and handwriting pen input. However, a problem arises in these electronic devices when the device detects the hand of a user holding a pen input device (handwriting input pen) as a touch input when the user's hand contacts or rests on the touch panel, which may lead to erroneous/inadvertent input detection.

One method considered to be a solution to this problem may be a method which does not allow touch input detection at the time of pen input, for example. According to this method, however, simultaneous input operation of both touch input and handwriting pen input, which allows the user to perform handwriting pen input by the right hand (for example) while simultaneously supplying touch input with the left hand (for example) is not possible or very difficult.

Accordingly, there is a demand for an electronic device providing simultaneous input operations of both touch input and handwriting pen input without erroneous/inadvertent touch input detection.

### DESCRIPTION OF THE DRAWINGS

FIG. 1 illustrates the external appearance of an electronic device according to an embodiment.

FIG. 2 depicts an input unit (touch panel) of the electronic device according to the embodiment.

FIG. 3 depicts a pen device (handwriting input pen) capable of inputting handwriting to the electronic device according to the embodiment.

FIG. 4 is a block diagram of the electronic device according to the embodiment.

FIG. 5 illustrates formation of a touch operation non-detection portion in a part of a touch panel when a user inputs handwriting using a pen device in the electronic device according to the embodiment.

FIG. 6 illustrates formation of the touch operation non-detection portion in a part of the touch panel based on relative inclinations of the electronic device and the pen device in the electronic device according to the embodiment.

FIG. 7 illustrates another example of the formation of the touch operation non-detection portion containing a diagonal between a pen tip and a pen tail of the pen device in the electronic device according to the embodiment.

FIG. 8 illustrates a further example in which the touch operation non-detection portion that is formed is a relatively small area in the electronic device according to the embodiment.

FIG. 9 illustrates a still further example in which the touch operation non-detection portion is displayed as an identifiable area in the electronic device according to the embodiment.

FIGS. 10A and 10B illustrate a still further example in which the touch operation non-detection portion is configured such that the size of the touch operation non-detection portion can switch in accordance with changes of the relative inclinations of the electronic device and the pen device in the electronic device according to the embodiment.

FIG. 11 is a flowchart of an operation of the electronic device according to the embodiment.

### DETAILED DESCRIPTION

In general, according to one embodiment, there is provided an electronic device capable of facilitating simultaneous input operation of both touch input and handwriting pen input, and thereby improving convenience of the electronic device.

An electronic device according to one embodiment includes a receiver that receives inclination (pen angle/orientation) information from a pen device. The electronic device includes a touch panel display unit which can receive both user touch input (e.g., from user fingertips) and pen device input (e.g., from an electronic stylus). The electronic device includes a calculation module that calculates relative inclinations of the electronic device (for example, the display plane of the display unit) and the pen device based on inclination information from the pen device. In some embodiments, an inclination of the electronic device may also be determined when not otherwise known or fixed.

The electronic device further includes an instruction module that issues an instruction for providing a touch operation non-detection portion in a portion of a touch panel based on the calculated relative inclination. A touch operation non-detection potion is an area of the touch panel display unit in which user touch input is intentionally not detected (or is otherwise ignored) such that pen device input may be input on the touch panel display unit without (or with a significantly reduced chance of) inadvertent detection of user touch input.

An example embodiment is hereinafter described with reference to the drawings.

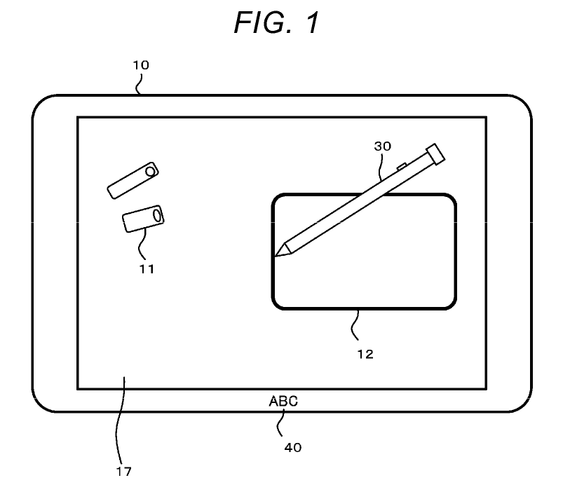

FIG. 1 illustrates the external appearance of an electronic device according to the example embodiment.

In this embodiment, an electronic device (e.g., tablet-type device) 10 includes a touch panel 17 which is an input detection unit also having the function of an image display unit as well.

The electronic device 10 can simultaneously receive both touch input and pen input using a pen device 30 via the touch panel 17.

A user of the electronic device 10 can touch the touch panel 17 by using a finger 11. In this depiction, the electronic device 10 is a tablet-type device, held in a “landscape” orientation—that is, the longer axis of the touch panel is a horizontal direction. Here, the electronic device 10 is positioned in such a direction that the longer side thereof extends horizontally with logos 40 of characters “ABC” located on the front side of the device. The user can use the touch panel 17 so as to perform touch input (e.g., a multi-touch operation), for example selecting displayed icons or providing navigation gestures to open/close applications, move display windows, or the like.

In addition to the touch input using a finger 11, the user can touch the touch panel 17 using a pen device 30 and can simultaneously perform pen input using the pen device and touch input using finger 1130, for example.

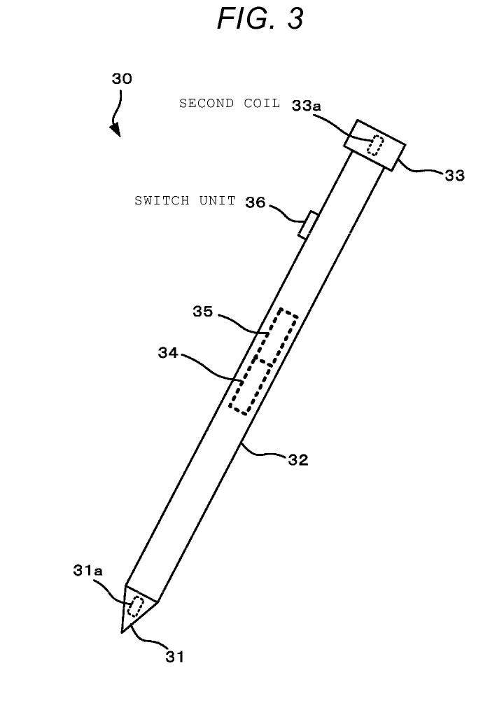

In this case, a part of the input unit (touch panel 17) at the position proximate to a pen stylus 32 (depicted in FIG. 3) of the pen device (handwriting input pen) 30 is controlled by a CPU 101 (or the like) such that a touch operation non-detection portion 12 (non-detection portion) can be formed. The touch operation non-detection portion 12 is an area where detection of touch input is not allowed—that is, touch input detected in non-detection portion 12 is ignored or not otherwise treated as touch input detected outside of non-detection portion 12.

While a tablet-type device is discussed herein as an example of the electronic device 10, the electronic device 10 in this embodiment is not limited to a tablet-type device but maybe other types of electronic devices such as a smart phone and a TV set.

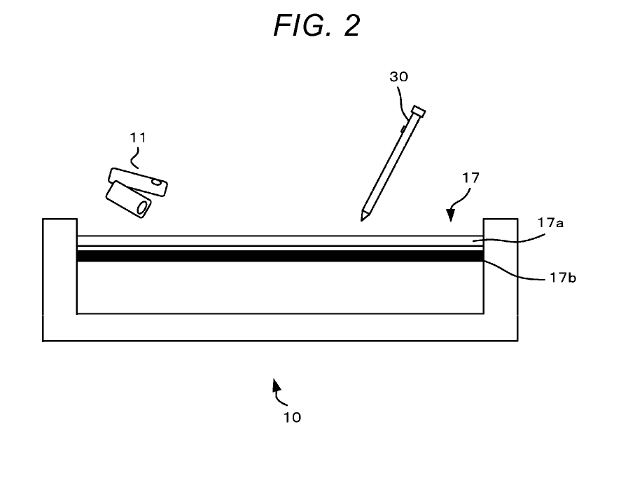

FIG. 2 illustrates a structure example of the input unit (touch panel) of the electronic device according to this embodiment.

In this embodiment, the input unit (touch panel) 17 includes a touch sensor 17a which detects touch input (e.g., from a user's finger) by the user and other inputs, and a digitizer 17b capable of detecting a position of a pen tip 31 of the pen device 30 and the input operation by the input pen 30.

The touch sensor 17a is constituted by an electrostatic capacitance type touch panel, for example.

The electrostatic capacitance type touch panel includes a surface type and a projection type, for example. Both of these types catch changes of the capacitance between the finger tip of the user and a conductive film to detect the position of the finger tip.

Such expression or operation which displays a cursor before touch of the finger on the surface of the sensor (touch sensor 17a) is also allowed by utilizing the characteristics of the touch panel that electrostatic coupling is caused only by approach of the finger to the surface of the sensor.

In general, the electrostatic capacitance type touch panel of the surface type includes three layers of a cover, a conductive film, and a glass substrate. The conductive film is attached to the glass substrate. Electrodes are provided at the four corners of the glass substrate. According to this conductive film, a uniform electric field is generated.

When the finger of the user touches the display screen, weak current coming from a driving circuit passes through terminals at the corners, the conductive film, and the cover, and then flows through the finger and constitutes a closed circuit between the ambient environment including the ground and the driving circuit. According to this structure, the position of the finger of the user can be detected based on the measurement of the proportion of the current amount at the terminals of the four corners conducted on the driving circuit side.

On the other hand, the electrostatic capacitance type touch panel of the projection type can perform multiple-point detection of the finger tip. In general, the projection type includes an insulator film, an electrode layer positioned below the insulator film, and a substrate layer carrying a control IC.

The electrode layer disposed below the insulator film includes a large number of mosaic electrode patterns each constituted by ITO (indium tin oxide) or other transparent electrodes disposed in two layers in the longitudinal and lateral directions and disposed on a substrate made of glass, plastic, or other materials.

When the finger of the user touches the touch panel, the changes of the capacitances of the electrodes around the finger are caught through the two electrode rows in the longitudinal and lateral directions; thereby the position of the finger can be accurately detected. Accordingly, multiple-point detection can be performed by using the multiple electrode rows extending in the longitudinal and lateral directions.

The digitizer 17b detects input operation inputted using the pen device 30 by an electromagnetic induction system, for example.

In the electromagnetic induction system, a sensor unit is disposed below a liquid crystal screen to constitute a touch panel for pen input, for example.

In this embodiment, the touch panel 17 includes the electrostatic capacitance type touch sensor 17a and the electromagnetic induction type digitizer 17b.

According to this structure, both operation by the input pen 30 and operation by the finger 11 of the user can be received. When an electronic pen (input pen 30) is used, the strength of the pen-stroke, a side switch, or the like is also detected.

According to this system, therefore, a highly accurate electromagnetic induction pen may be used for inputting to an electrostatic touch (touch sensor 17a) for which input by a pen (input pen 30) is not generally permitted, without deteriorating visibility of the electrostatic touch.

However, when the user places his or her hand (not shown) holding the pen 30 on the touch panel 17 during pen input using the pen device 30, for example, there is a possibility that the electronic device 10 detects the hand placed on the touch panel 17 as touch input.

FIG. 3 illustrates a structure example of a pen device (handwriting pen) capable of inputting handwriting to the electronic device 10.

The pen device 30 is held by the right hand or left hand of the user, and used to input pen operations to the touch panel 17.

As illustrated in FIG. 3, the pen device 30, according to this embodiment, includes the pen stylus unit 32 corresponding to an area held by the user, and the pen tip 31 corresponding to an area of a so-called “pen tip” at which pen input to the touch panel 17 is sensed. The pen tip 31 is used in a “write” mode for handwriting input, for example.

According to this embodiment, the pen tip 31 may include an electromagnetic coil (first coil 31a). The digitizer 17b generates a magnetic field during input operation (“write mode”) for the electronic device 10, for example. Under this condition, when the electromagnetic coil (first coil 31a) attached to the tip of the pen device 30 approaches the digitizer 17b, the magnetic field changes due to the principle of electromagnetic induction. Based on detection of this change, the position of the pen device 30 is detected.

According to this embodiment, the pen device 30 includes the pen tail 33 at the position opposed to the pen tip 31 with the pen stylus (hold) unit 32 interposed therebetween.

For example, the pen stylus unit 32 includes an inclination detection unit 34 capable of detecting the inclination (inclination information) of the pen device 30, and an inclination information transmission unit 35 capable of transmitting the inclination information on the pen device 30 detected by the inclination detection unit 34 to the electronic device 10.

The inclination detection unit 34 includes a gyro sensor, for example, while the inclination information transmission unit 35 includes a transmission module, for example.

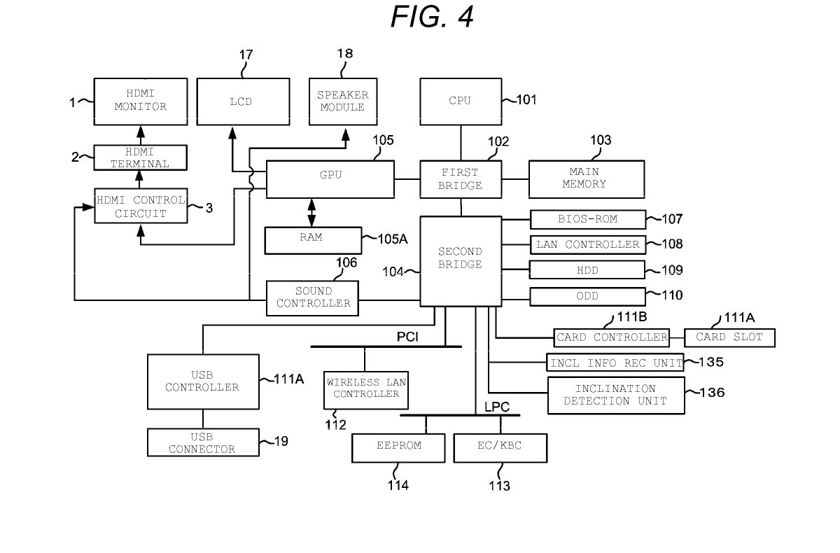

FIG. 4 is a block diagram showing a structure example of the electronic device according to this embodiment.

At least a part of the structure depicted may be accommodated in the electronic device 10 as electronic components.

The electronic device (tablet PC) 10 includes a CPU (central processing unit) 101, a first bridge 102, a main memory 103, a second bridge 104, a GPU (graphics processing unit) 105 (which may also be referred to as a “display controller”), a VRAM (video RAM: random access memory) 105A, a sound controller 106, a BIOS-ROM (basic input/output system read only memory) 107, and an LAN (local area network) controller 108.

The electronic device 10 (tablet PC) can also further include a hard disk drive (HDD (memory device)) 109, an optical disk drive (ODD) 110, a USB controller 111A, a card controller 111B, a wireless LAN controller 112, an embedded controller/keyboard controller (EC/KBC) 113, an EEPROM (electrically erasable programmable ROM) 114, and other components found in tablet personal computers, laptop personal computers, smart phone devices, and/or personal electronic devices.

The CPU 101 is a processor for controlling the operations of the respective parts provided within the electronic device (tablet PC) 10.

The CPU 101 executes stored instructions (BIOS instructions) accommodated within the BIOS-ROM 107. The BIOS is a program for hardware control.

The first bridge 102 is a bridge device connecting between a local bus of the CPU 101 and the second bridge 104. The first bridge 102 also includes a memory controller for access control of the main memory 103. The first bridge 102 also has the function of providing communication with the GPU 105 via a serial bus of PCI EXPRESS standard or the like, for example.

The GPU 105 is a display controller which controls the image display unit (LCD) 17 to provide a display monitor of the electronic device (tablet PC) 10.

A display signal generated by the GPU 105 is transmitted to the image display unit (e.g., a liquid crystal display (LCD)) 17. The GPU 105 may also transmit a digital image signal to an external display 1 (e.g., a high definition multimedia interface (HDMI) monitor) via a control circuit 3 (e.g., a HDMI control circuit) and a terminal 2 (e.g., a HDMI terminal).

The terminal 2 is a terminal connecting with the external display. The terminal 2 can transmit an uncompressed digital image signal and a digital audio signal to the external display 1 such as a TV unit via a single cable.

The control circuit 3 is an interface for transmitting the digital image signal to the external display 1 (called “monitor”) via the terminal 2.

The second bridge (depicted below first bridge 102 in FIG. 4) 104 controls the respective devices provided on a PCI (peripheral component interconnect) bus and the respective devices provided on an LPC (low pin count) bus. The second bridge 104, in this example, includes an IDE (integrated drive electronics) controller for controlling the HDD 109 and the ODD 110.

The second bridge 104 further has a function of communicating with the sound controller 106.

The sound controller 106 is a sound source device which outputs reproduction target audio data to a speaker module 18 or the control circuit 3.

The LAN controller 108 is a wired communication device which provides communication according to the IEEE (Institute of Electrical and Electronics Engineers) 802.3 standard, for example, while the wireless LAN controller 112 is a wireless communication device which provides wireless communication using IEEE 802.11g standard, for example.

The USB controller 111A provides communication with an external device meeting USB 2.0 standard (and connected via a USB connector 19), for example.

For example, the USB controller 111A can be used for receiving an image data file stored in a digital camera or the like.

The card controller 111B is inserted into a card slot formed in a computer (e.g., notebook personal computer) main body 11. The card controller 111B executes data writing and data reading to and from a memory card such as an SD card.

The EC 113 is an embedded controller for power management.

The EC 113 has the function of turning on and off the power source of the electronic device (tablet PC) 10 in accordance with the status of a power button 14 operated by the user.

The display control according to this embodiment is performed based on a program recorded in the main memory 103, the HDD 109 or others and executed in accordance with an instruction from the CPU 101, for example.

The electronic device 10 in this embodiment includes an inclination information reception unit 135 which receives inclination information on the pen device 30 transmitted by the inclination information transmission unit 35 provided with the pen device 30, for example.

The inclination information on the pen device 30 is detected within the electronic device 10. Based on this information, the input unit (touch sensor 17a) is controlled by the CPU 101 such that a part of the input unit at the position opposite to the pen stylus 32 of the pen device 30 becomes an area where detection of touch input is not allowed This, portion of the touch input unit 17 may be referred to as the touch operation non-detection portion 12).

In this embodiment, the electronic device 10 includes an electronic device inclination detection unit (e.g., gyro sensor) 136 which can detect information concerning the direction (inclination/orientation) of the electronic device 10.

The electronic device 10 in this embodiment also includes a reception unit (pen inclination information reception unit 135) which receives information related to the pen device 30 that is outputted from the pen device 30.

The electronic device 10 further includes a calculation unit (e.g., CPU 101) which calculates relative inclinations of the electronic device 10 and the pen device 30 based on the direction information from the electronic device 10 and the information from the pen device 30.

Based on the relative inclinations thus calculated, the touch operation non-detection portion 12 is provided in a part of the image display unit (touch panel) 17.

Instructions associated with performing these operations can be issued from an instruction unit (e.g., CPU 101), for example.

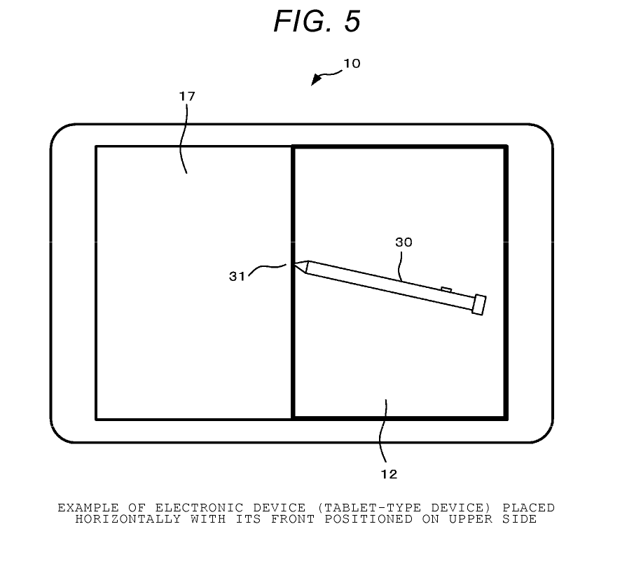

FIG. 5 illustrates a condition in which the touch operation non-detection portion 12 is provided in a part of the touch panel at the time of handwriting input by the user using the pen device 30 in the electronic device according to this embodiment.

In this embodiment, the relative inclinations of the electronic device 10 and the pen device 30 are calculated when the pen device 30 operated by the user reaches a point within a predetermined distance from the image display unit 17, for example, as illustrated in FIG. 5.

The predetermined distance in this embodiment is several centimeters, for example. The length of the predetermined distance may be varied as necessary according to tablet sensitivity and/or pen dimensions, for example.

The touch operation non-detection portion 12 is provided in a part of the image display unit 17 based on the calculated relative inclination of the image display unit 17 and the pen device 30 for example.

In this case, the touch operation non-detection portion 12 is disposed in the right part of the image display unit 17 shown in FIG. 5, as an example.

The touch operation non-detection portion 12 is configured to detect input from the pen device 30, but not to detect touch operation by the user. In some embodiments, the touch operations by user within touch operation non-detection portion 12 may detected, but effectively ignored as input signals.

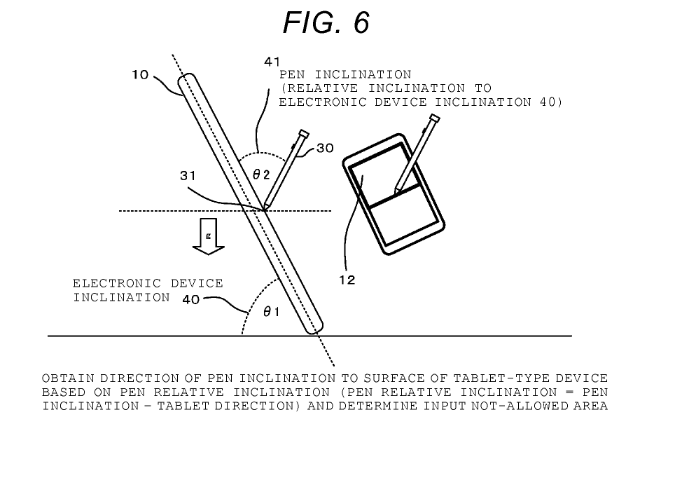

FIG. 6 illustrates a condition in which the touch operation non-detection portion is formed in a part of the touch panel based on the relative inclinations of the electronic device and the pen device in the electronic device according to this embodiment.

According to this embodiment, the direction of inclination of the pen device 30 with respect to the surface (input surface of touch panel) of the electronic device 10 is calculated based on the relative inclination of the pen device 30, for example, so as to determine the touch input not-allowed area 12 as illustrated in FIG. 6.

The relative inclination of the pen device 30 can be calculated by subtracting the direction of the electronic device 10 (θ1) from the inclination of the pen device 30 (θ2), for example.

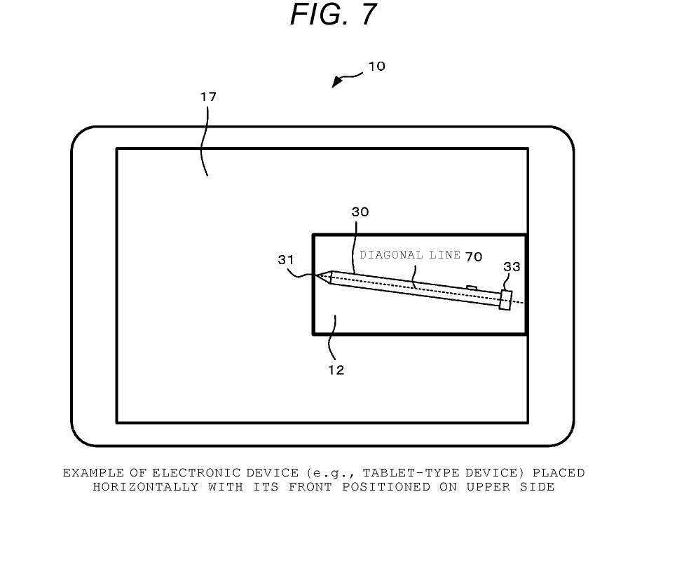

FIG. 7 illustrates another example in which the touch operation non-detection portion 12 is formed in such that a part of the touch operation non-detection portion 12 contains a projected line corresponding to a diagonal line between the pen tip and the pen tail in the electronic device according to this embodiment.

In this case, the touch operation non-detection portion 12 is so configured to include a projected line (that is, projected onto the display unit 17) of the diagonal between the pen tip (starting point) 31 and the pen tail 33 as illustrated in FIG. 7. The projection of the diagonal may extend past an outer edge of the display unit 17, but the non-detection portion 12 need only include those portions that are overlapping the display unit 17.

In this example, the touch operation non-detection portion 12 has an approximately quadrangular shape, and has a size smaller than that of the example shown in FIG. 5 so as to reduce obstruction to the touch operation by the user as much as possible.

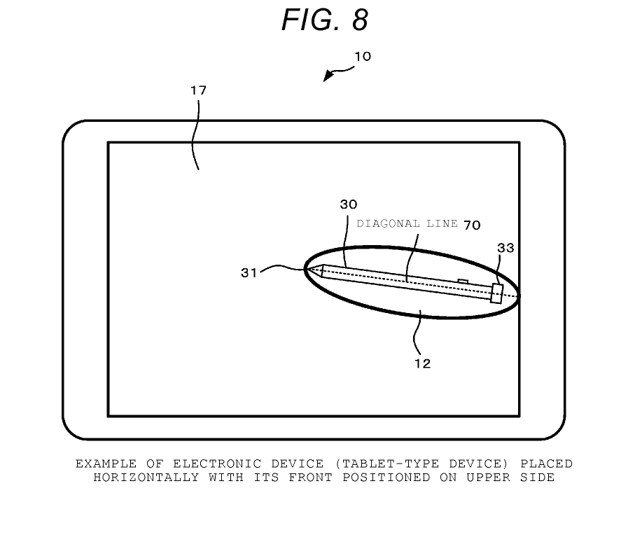

FIG. 8 illustrates a further example in which the touch operation non-detection portion 12 is formed as a relatively narrow area in the electronic device according to this embodiment.

As illustrated in FIG. 8, the touch operation non-detection portion 12 in this example is so configured that non-detection portion 12 substantially contains the projected diagonal between the pen tip (starting point) 31 and the pen tail 33.

In this case, the touch operation non-detection portion 12 has a round shape (or elliptical), and has a smaller size so as to reduce obstruction to the touch operation by the user as much as possible.

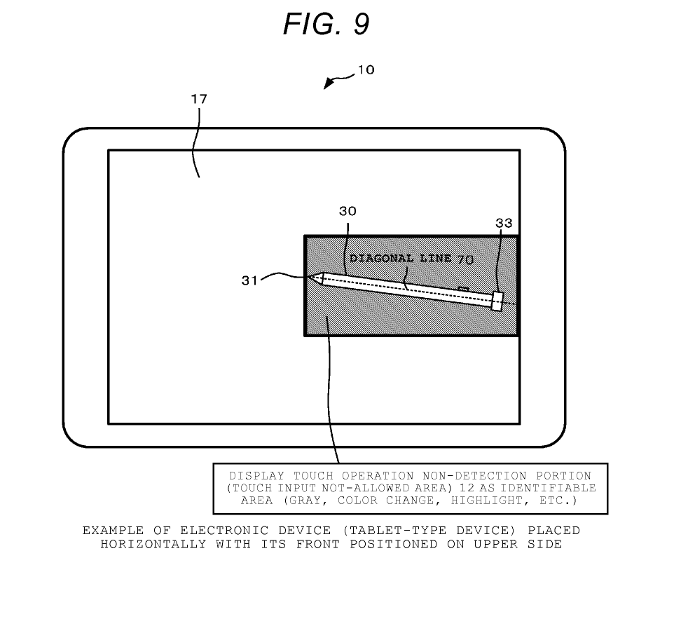

FIG. 9 illustrates a still further example of the touch operation non-detection portion 12 displayed on the touch panel 17 as an identifiable area (e.g., shaded, gray, highlighted, color-shifted, and/or color-changed region, etc.) in the electronic device according to this embodiment.

As illustrated in FIG. 9, the touch operation non-detection portion 12 in this example is so configured that non-detection portion 12 substantially contains a projected diagonal between the pen tip (starting point) 31 and the pen tail 33.

According to this example, the touch operation non-detection portion (touch input not-allowed area) 12 is displayed as an identifiable area, that is, so configured that the user can easily identify the touch operation non-detection portion (touch input not-allowed area) 12 or otherwise distinguish the touch operation non-detection portion 12 from the other portions of display unit 17.

The touch operation non-detection portion (touch input not-allowed area) 12 may be distinct in a formation of a gray display area, an area having a different color for identification from the display screen, or a highlight display, for example, so that the user can easily identify the touch operation non-detection portion 12.

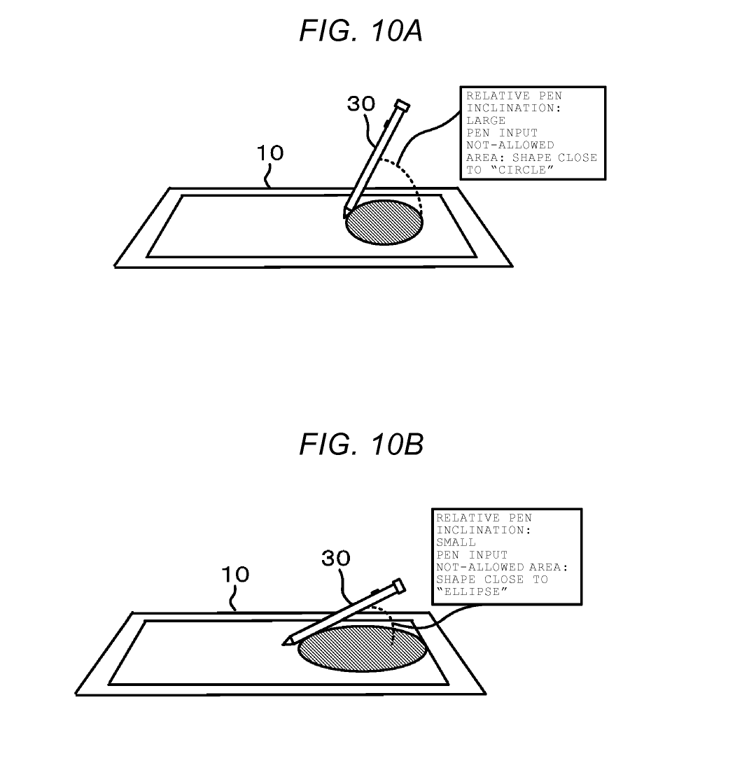

FIGS. 10A and 10B illustrate a still further example in which the touch operation non-detection portion 12 is so configured that the size thereof can switch in accordance with changes of the relative inclinations of the electronic device and the pen device in the electronic device according to this embodiment.

According to the example shown in FIG. 10A, the touch operation non-detection portion (touch input not-allowed area) 12 is decreased to have an approximately round shape, for example, when the relative inclination of the pen device 30 is “large”, in other words, the pen device 30 is steeply angled with respect to the electronic device 10.

On the other hand, according to the example shown in FIG. 10B, the touch operation non-detection portion 12 is increased to have an approximately elliptic shape, for example, when the relative inclination of the pen device 30 is “small”, in other words, the pen device 30 is less steeply angled with respect to the electronic device 10.

In these cases, the changes of the relative inclinations of the electronic device and the pen device can be appropriately determined and changed for every one degree, five degrees, ten degrees or other units of degrees including sub-degree increments, for example.

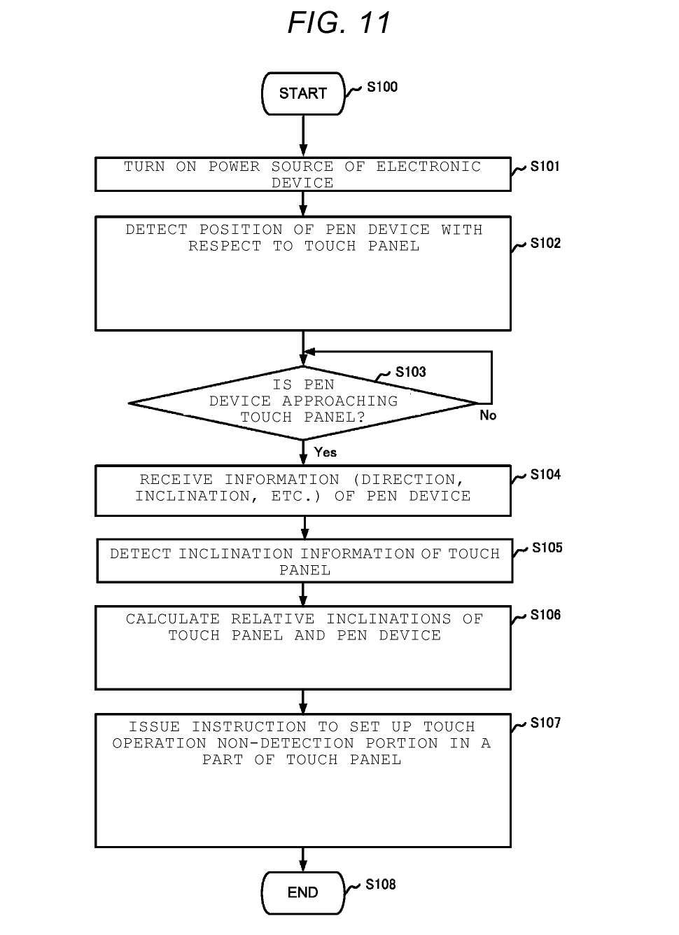

FIG. 11 is a flowchart showing operation of the electronic device according to this example embodiment.

Step S100 is a start step in this operation.

Step S101 is a step for turning on the power source of the electronic device 10.

Step S102 is a step for detecting the position of the pen device 30 (e.g. position of pen tip 31) with respect to the touch panel 17 of the electronic device 10.

For example, a position of the pen tip 31 with respect to the touch panel 17 is detected by using a magnetic field generated from the digitizer 17b based on detection of the change of this magnetic field generated when the first coil 31a provided within the pen tip 31 or in the vicinity thereof comes close to or goes away from the touch panel 17.

Step S103 is a step for determining whether the pen device 30 (e.g., pen tip 31) approaches the touch panel 17 (for example, whether the distance between the pen tip 31 and the touch panel 17 is a predetermined length or less). That is, step S103 is a determination whether pen device 30 is proximate to the touch panel, such as for example when a user begins to use pen device 30 to input handwriting to electronic device 10.

When approach of the pen device 30 (pen tip 31) to the touch panel 17 is detected, the flow proceeds to Step S104 (Yes). When approach of the pen device 30 (pen tip 31) to the touch panel 17 is not detected, the process in this step is repeated (No).

Step S104 is a step at which the electronic device 10 receives information concerning the pen device 30 (such as pen direction and angle of inclination) detected by the inclination detection unit (e.g., gyro sensor) 34 and outputted from the pen device 30.

Step S105 is a step at which the detecting direction (inclination) information for the electronic device 10 using the inclination detection unit (gyro sensor) in the electronic device 10.

Step S106 is a step in which the relative inclinations of the electronic device 10 and the pen device 30 based on the detected direction (inclination) information on the electronic device 10 and the received information (such as direction and inclination) on the pen device 30 is calculated.

Step S107 is a step at which the CPU 101 of the electronic device 10 issues an instruction for providing with the touch operation non-detection portion 12 having a size or a shape set beforehand (such as substantially circular, elliptic, lozenge-shaped (rectangular with rounded end portions), polygonal, and rectangular shape) in a part of the touch panel 17 of the electronic device 10 based on the relative inclination of the pen device 30 with respect to the electronic device 10 calculated in the preceding step S106.

The respective pieces of information used (e.g., selected shapes and sizes of non-detection portion 12) herein may be stored in the EEPROM 114 beforehand, for example.

At this step, the touch operation non-detection portion (touch input not-allowed area) 12 may be optionally configured to contain a projected line (diagonal) along which the pen tip 31 and the pen tail 33 diagonally face to each other.

Moreover, the touch operation non-detection portion 12 may be optionally displayed as an identifiable area.

The step S108 is an end step where the process performed herein ends.

In the electronic device 10 capable of receiving both touch input and input of the pen device 30 from the user through the touch panel 17, there is a possibility that the electronic device 10 erroneously determines touch input from the user, for example, when the back of the user' s hand touches the touch panel 17 during use of the pen device 30 by the user. According to this example embodiment, this erroneous determination can decrease.

More specifically, in this embodiment, a sensor (inclination detection unit (gyro) 33) is provided on the pen device 30, for example. This structure allows detection of information on the pen device 30 (such as direction of pen tip and inclination of pen device 30), and the detected information can be transmitted to the electronic device 10.

After reception of the information, the electronic device 10 calculates how the pen device 30 is inclined with respect to the surface (touch panel 17) of the electronic device 10 (i.e., relative inclination) based on the information on the pen device 30 (such as direction of pen tip 31 and inclination of pen device 30) and the direction and inclination of the electronic device 10.

Subsequently, the touch operation non-detection portion (input not-allowed area) 12 is formed on the display surface of the electronic device 10.

In this case, the display area other than the touch operation non-detection portion 12 can simultaneously receive both the touch input and the pen input, for example.

In this embodiment, the electronic device 10 may be configured to receive status information on the pen device 30 (such as direction of pen device 30 and inclination information on pen device 30) from the pen device 30 only when the pen tip 31 of the pen device 30 comes within a predetermined distance from the electronic device 10.

In this embodiment, the electronic device 10 may be so configured as not to be provided with the touch operation non-detection portion (input not-allowed area) 12 when the electronic device 10 does not receive the condition information on the pen device 30, for example, when the pen device 30 is farther away from the electronic device 10 than the predetermined distance.

In some embodiments, the electronic device 10 may be configured so that the touch operation non-detection portion 12 is an area having a specific shape, lying on the side where the pen tip 31 and the pen device 30 are inclined toward the touch panel 17, and including a diagonal connecting the corners of the touch panel 17.

In some embodiments, the electronic device 10 may be configured to display the touch operation non-detection portion 12 on the input display area at the time when the electronic device 10 determines the touch operation non-detection portion 12.

In some embodiments, the electronic device 10 may be configured so that the range of the touch operation non-detection portion 12 is dynamically changed in accordance with the inclination of the pen device 30 with respect to the surface (touch panel 17).

In this case, the level of the change in accordance with the inclination can be arbitrarily set in an appropriate manner for each one degree, five degrees, ten degrees, or other units of degrees, for example.

Namely, in some embodiments, the electronic device includes a receiver (pen inclination information reception unit 135) which receives information on the pen device 30 outputted from the pen device 30. The reception unit (receiver) 135 may be provided by using dedicated hardware components or more general components such as a wireless network receiver and software components.

The electronic device further includes a calculation module (e.g., CPU 101) which calculates the relative inclinations of the electronic device 10 and the pen device 30 based on the direction information for the electronic device 10 and the information for the pen device 30.

The electronic device further includes an instruction module (e.g., CPU 101) which issues an instruction for providing with the touch operation non-detection portion 12 in a part of the touch panel 17 based on the calculated relative inclinations. The functions of the calculation module and the instruction module may be provided using a single processor or separate processors.

The electronic device further includes the electronic device information detection unit (inclination detection unit (e.g., gyro sensor) 136) which can detect the required direction information for the electronic device 10.

The pen device 30 includes a detection unit (inclination detection unit (e.g., gyro sensor) 34) which can detect information for the pen device 30.

The functions of various embodiments can be performed by using software components. Thus, embodiments of the present disclosure include a non-transitory, computer-readable medium storing instructions that when executed cause a computer to perform the disclosed functions and operations.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An electronic device, comprising:
a touch panel display unit configured to receive inputs from a pen device and touch inputs;
a receiver configured to receive pen inclination information from the pen device;
a calculation module configured to calculate a relative inclination of the touch panel display unit and the pen device based on the pen inclination information from the pen device; and
an instruction module configured to issue an instruction for providing a touch operation non-detection portion in a portion of the touch panel display unit according to the calculated relative inclination.

2. The electronic device according to claim 1, further comprising:
an electronic device information detector configured to detect inclination of the touch panel display unit, wherein the calculation module is configured to use the detected inclination of the touch panel display unit to calculate the relative inclination of the touch panel display unit and the pen device.

3. The electronic device according to claim 1, wherein the electronic device information detection unit includes a gyroscopic sensor.

4. The electronic device according to claim 1, wherein the touch operation non-detection portion has a size that is predetermined.

5. The electronic device according to claim 4, wherein the touch operation non-detection portion is one of a circular shape and a rectangular shape.

6. The electronic device according to claim 1, wherein the touch operation non-detection portion encompasses a projection on to the touch panel display unit of a diagonal line extending between a pen tip and a pen tail of the pen device.

7. The electronic device according to claim 1, wherein the touch operation non-detection portion is displayed on the touch panel display unit as an identifiable area.

8. The electronic device according to claim 7, wherein the identifiable area comprises a gray-shaded region.

9. The electronic device according to claim 1, wherein a size of the touch operation non-detection portion varies in accordance with changes in the relative inclination of the touch panel display unit and the pen device.

10. The electronic device according to claim 1, wherein the pen inclination information is generated by a gyroscopic sensor in the pen device.

11. A control method for controlling an electronic device having a touch panel display unit configured to receive inputs from a pen device and touch inputs, comprising:
receiving pen inclination information from the pen device;
calculating a relative inclination of the touch panel display unit and the pen device based on the received pen inclination information; and
providing a touch operation non-detection portion in a portion of the touch panel display unit according to the calculated relative inclination.

12. The control method of claim 11, further comprising:
detecting an inclination of the touch panel display unit.

13. The control method of claim 12, wherein detecting the inclination of the touch panel display unit includes receiving output from a gyroscopic sensor associated with the touch panel display unit.

14. The control method of claim 11, further comprising:
detecting a distance of the pen device from the touch panel display unit, and providing the touch operation non-detection portion only when the pen device is within a predetermined distance from the touch panel display unit.

15. The control method of claim 11, further comprising:
indicating the touch operation non-detection portion in the portion of the touch panel display unit as an identifiable portion.

16. The control method of claim 11, further comprising:
varying a size of the touch operation non-detection portion in accordance with changes in the calculated relative inclination of the touch panel display unit and the pen device.

17. The control method of claim 11, further comprising:
varying a shape of the touch operation non-detection portion in accordance with changes in the calculated relative inclination of the touch panel display unit and the pen device.

18. A non-transitory computer readable storage medium storing a program which when executed causes an electronic device having a touch panel display unit configured to receive inputs from a pen device and touch inputs to perform steps of a method, comprising:
receiving pen inclination information from the pen device;
calculating a relative inclination of the touch panel display unit and the pen device based on the received pen inclination information; and
providing a touch operation non-detection portion in a portion of the touch panel display unit according to the calculated relative inclination.

19. The non-transitory computer readable storage medium of claim 18, the method further comprising:
detecting an inclination of the touch panel display unit; and
using the detected inclination of the touch panel display unit in calculating the relative inclination of the touch panel display unit and the pen device.

20. The non-transitory computer readable storage medium of claim 18, further comprising:
varying a size of the touch operation non-detection portion in accordance with changes in the calculated relative inclination of the touch panel display unit and the pen device.
